(19) United States
(12) Patent Application Publication
(10) Pub. No.: US 2026/0153965 A1
(43) Pub. Date: Jun. 4, 2026

(54) ELECTRONIC DEVICE INCLUDING SENSOR FOR IDENTIFYING LOCATION OF ELECTRONIC PEN

(71) Applicant: Samsung Electronics Co., Ltd., Suwon-si (KR)

(72) Inventors: Sungsoo PARK, Suwon-si (KR); Byunghoon KANG, Suwon-si (KR); Myeongsil PARK, Suwon-si (KR); Juwan PARK, Suwon-si (KR); Byungduk YANG, Suwon-si (KR)

(21) Appl. No.: 19/465,550

(22) Filed: Jan. 30, 2026

Related U.S. Application Data
(63) Continuation of application No. PCT/KR2024/007961, filed on Jun. 11, 2024.

(30) Foreign Application Priority Data
Aug. 8, 2023 (KR) 10-2023-0103816
Aug. 23, 2023 (KR) 10-2023-0110479
Oct. 10, 2023 (KR) 10-2023-0134694

(51) Int. Cl. G06F 3/044; G06F 3/0354

(52) U.S. Cl. CPC G06F 3/0442; G06F 3/03545; G06F 3/0443

(57) ABSTRACT

An electronic device is provided. The electronic device includes a display including a first flat portion, a second flat portion, and a foldable folding portion, a touch sensor disposed in the display, a support plate supporting the display, a first group of conductive patterns each extending in a first direction and disposed in the touch sensor, a second group of conductive patterns which each extend in a second direction intersecting the first direction, and are disposed on the support plate, and at least one control circuit, wherein the at least one control circuit is configured to transmit, to an electronic pen, a first signal for inducing electromagnetic resonance, and receive, from the electronic pen through the first group of conductive patterns and the second group of conductive patterns, a second signal for identifying the location of the electronic pen.

### CROSS-REFERENCE TO RELATED APPLICATION(S)

This application is a continuation application, claiming priority under 35 U.S.C. § 365(c), of an International application No. PCT/KR 2024/007961, filed on Jun. 11, 2024, which is based on and claims the benefit of a Korean patent application number 10-2023-0103816, filed on Aug. 8, 2023, in the Ministry of Intellectual Property, of a Korean patent application number 10-2023-0110479, filed on Aug. 23, 2023, in the Ministry of Intellectual Property, and of a Korean patent application number 10-2023-0134694, filed on Oct. 10, 2023, in the Ministry of Intellectual Property, the disclosure of each of which is incorporated by reference herein in its entirety.

### BACKGROUND

### 1. Field

The disclosure relates to an electronic device including a sensor for identifying a position of an electronic pen.

### 2. Description of Related Art

In order to change a size of a display region that is visible from an outside, a shape of a display may be changed according to a state of an electronic device. For example, the display of an electronic device may be referred to as a flexible display that is deformable. To protect the deformable display, the electronic device may include a structure for protecting the display.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an electronic device including a sensor for identifying a position of an electronic pen.

Additional aspects will be set forth in part in the description which follows and, in part, will be apparent from the description, or may be learned by practice of the presented embodiments.

In accordance with an aspect of the disclosure, an electronic device is provided. The electronic device includes a display including a first planar part, a second planar part, and a folding part disposed between the first planar part and the second planar part and foldable. According to an embodiment, the electronic device includes a touch sensor for receiving a touch input from outside of the electronic device and disposed in the display. According to an embodiment, the electronic device includes a supporting plate supporting the display and including a plurality of openings aligned with the folding part. According to an embodiment, the electronic device includes a first group of conductive patterns disposed in the touch sensor and respectively extending in a first direction and a second group of conductive patterns disposed on the supporting plate and respectively extending along a second direction crossing the first direction. According to an embodiment, the electronic device includes at least one control circuit. According to an embodiment, the at least one control circuit is configured to transmit a first signal, for inducing an electromagnetic resonance, to an electronic pen through at least one of the first group of conductive patterns and the second group of conductive patterns. According to an embodiment, the at least one control circuit is configured to receive a second signal from the electronic pen, for identifying a position of the electronic pen, caused by the first signal, through the first group of conductive patterns and the second group of conductive patterns.

In accordance with another aspect of the disclosure, an electronic device is provided. The electronic device includes a first housing. According to an embodiment, the electronic device may include a second housing. According to an embodiment, the electronic device includes a hinge structure rotatably connecting the first housing and the second housing. According to an embodiment, the electronic device includes a display including a first planar part disposed on the first housing, a second planar part disposed on the second housing, and a folding part disposed between the first planar part and the second planar part and foldable. According to an embodiment, the electronic device includes a touch sensor for receiving a touch input on the display and integrally formed with the display. According to an embodiment, the electronic device may include a supporting plate supporting the display and including a plurality of openings aligned with the folding part. According to an embodiment, the electronic device includes a first group of conductive patterns disposed in the touch sensor and respectively extending in a first direction and a second group of conductive patterns disposed on the supporting plate and respectively extending along a second direction crossing the first direction. According to an embodiment, the electronic device includes at least one control circuit. According to an embodiment, the at least one control circuit is configured to provide power to at least one of the first group of conductive patterns and the second group of conductive patterns to transmit a first signal for inducing an electromagnetic resonance to an electronic pen. According to an embodiment, the at least one control circuit is configured to receive a second signal from the electronic pen, for identifying a position of the electronic pen, caused by the first signal, through the first group of conductive patterns and the second group of conductive patterns.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram of an electronic device in a network environment according to an embodiment of the disclosure;

FIG. 2A illustrates an example of an unfolded state of an electronic device according to an embodiment of the disclosure;

FIG. 2B illustrates an example of a folded state of an electronic device according to an embodiment of the disclosure;

FIG. 2C is an exploded view of an electronic device according to an embodiment of the disclosure;

FIG. 3 is a cross-sectional view illustrating an example in which an electronic device is cut along line A-A′ of FIG. 2A according to an embodiment of the disclosure;

FIG. 4 indicates a relationship between a display, an electromagnetic sensor, and an electronic pen of an electronic device according to an embodiment of the disclosure;

FIG. 5 is a top view of a touch sensor of an electronic device according to an embodiment of the disclosure;

FIG. 6A is a top view of a supporting plate and electromagnetic sensor, according to an embodiment of the disclosure;

FIG. 6B is a cross-sectional view illustrating an example in which a supporting plate and electromagnetic sensor are cut along line B-B′ of FIG. 6A according to an embodiment of the disclosure;

FIG. 6C is a cross-sectional view illustrating an example of cutting a supporting plate and electromagnetic sensor, according to an embodiment of the disclosure;

FIG. 7 indicates a relationship between an electromagnetic sensor, touch sensor, and supporting plate, according to an embodiment of the disclosure;

FIG. 8 is a top view of a supporting plate and electromagnetic sensor, according to an embodiment of the disclosure; and

FIG. 9 is a top view of a supporting plate according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

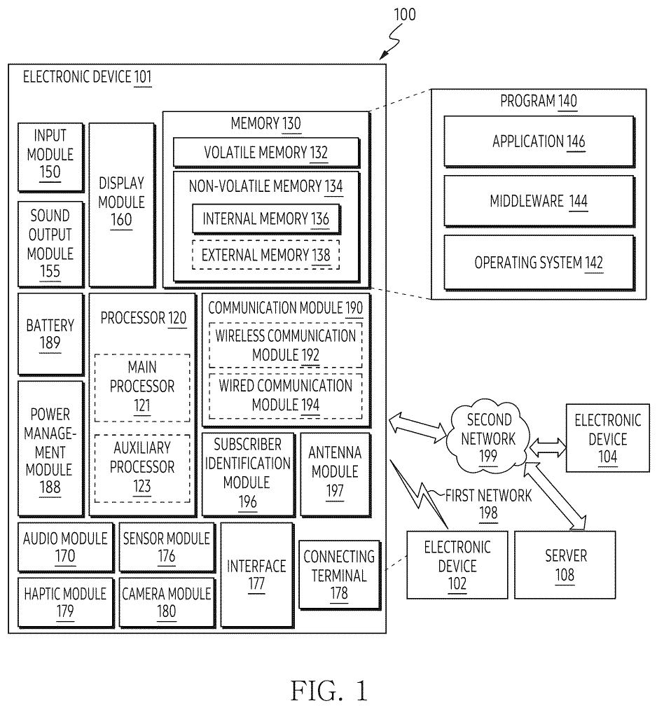

FIG. 1 is a block diagram illustrating an electronic device 101 in a network environment 100 according to an embodiment of the disclosure.

Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a fifth generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, an RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

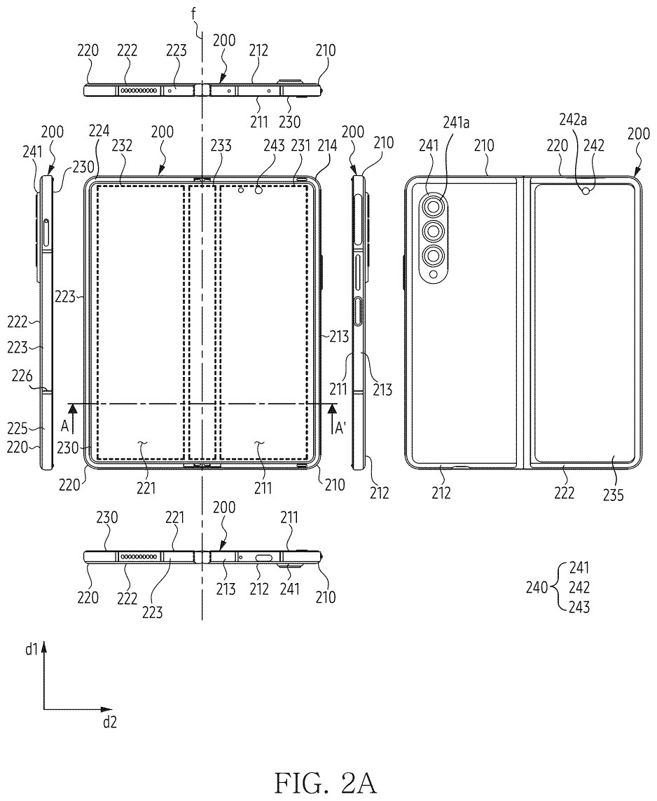

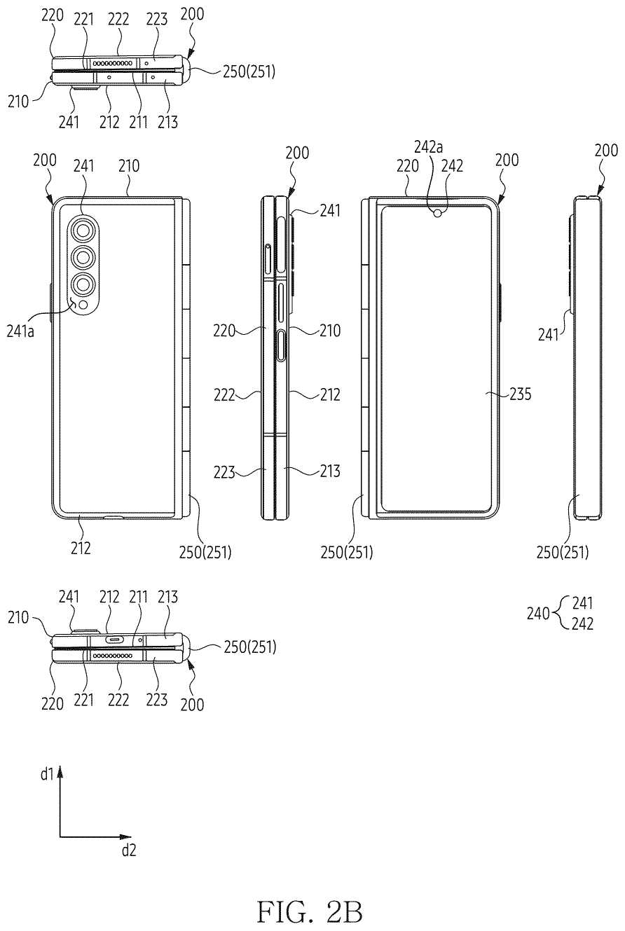

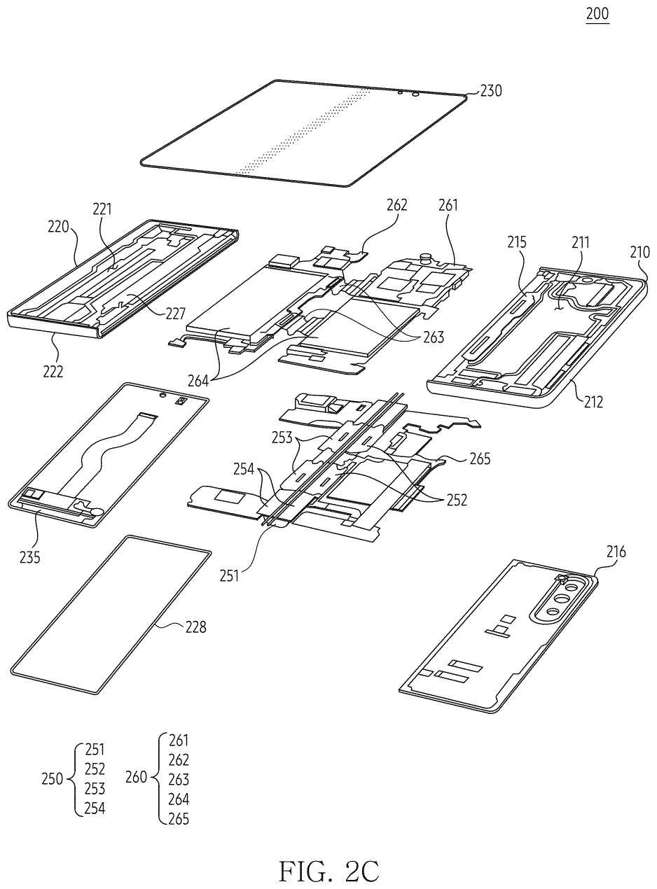

FIG. 2A illustrates an example of an unfolded state of an electronic device according to an embodiment of the disclosure, FIG. 2B illustrates an example of a folded state of an electronic device according to an embodiment of the disclosure, and FIG. 2C is an exploded view of an electronic device according to an embodiment of the disclosure.

Referring to FIGS. 2A, 2B, and 2C, an electronic device 200 (e.g., the electronic device 101 of FIG. 1) may include a first housing 210, a second housing 220, a display 230, at least one camera 240 (e.g., the camera module 180 of FIG. 1), a hinge structure 250, and/or at least one electronic component 260.

The first housing 210 and the second housing 220 may form at least a portion of an outer surface of the electronic device 200 that may be gripped by a user. The at least a portion of the outer surface of the electronic device 200 defined by the first housing 210 and the second housing 220 may be in contact with a part of a body of the user when the electronic device 200 is used by the user. According to an embodiment, the first housing 210 may include a first surface 211, a second surface 212 facing the first surface 211 and spaced apart from the first surface 211, and a first side surface 213 covering at least a portion of the first surface 211 and the second surface 212. The first side surface 213 may connect a periphery of the first surface 211 and a periphery of the second surface 212. The first surface 211, the second surface 212, and the first side surface 213 may define an inner space of the first housing 210. According to an embodiment, the first housing 210 may provide the space formed by the first surface 211, the second surface 212, and the first side surface 213 as a space for disposing components of the electronic device 200.

According to an embodiment, the second housing 220 may include a third surface 221, a fourth surface 222 facing the third surface 221 and spaced apart from the third surface 221, and a second side surface 223 covering at least a portion of the third surface 221 and the fourth surface 222. The second side surface 223 may connect a periphery of the third surface 221 and a periphery of the fourth surface 222. The third surface 221, the fourth surface 222, and the second side surface 223 may define an inner space of the second housing 220. According to an embodiment, the second housing 220 may provide the space formed by the third surface 221, the fourth surface 222, and the second side surface 223 covering at least a portion of the third surface 221 and the fourth surface 222 as a space for mounting components of the electronic device 101. According to an embodiment, the second housing 220 may be coupled to the first housing 210 to be rotatable with respect to the first housing 210.

According to an embodiment, each of the first housing 210 and the second housing 220 may include a first protective member 214 and a second protective member 224, respectively. The first protective member 214 and the second protective member 224 may be disposed on the first surface 211 and the third surface 221 along a periphery of the display 230. According to an embodiment, the first protective member 214 and the second protective member 224 may prevent an inflow of foreign matter (e.g., dust or moisture) through a gap between the display 230 and the first housing 210 and between the display 230 and the second housing 220. For example, the first protective member 214 may surround a periphery of a first display region 231 of the display 230, and the second protective member 224 may surround a periphery of a second display region 232 of the display 230. The first protective member 214 may be formed by being attached to the first side surface 213 of the first housing 210, or may be formed integrally with the first side surface 213. The second protective member 224 may be formed by being attached to the second side surface 223 of the second housing 220, or may be integrally formed with the second side surface 223.

According to an embodiment, the first side surface 213 and the second side surface 223 may include a conductive material, a non-conductive material, or a combination thereof. For example, the second side surface 223 may include at least one conductive member 225 and at least one non-conductive member 226. The at least one conductive member 225 may include a plurality of conductive members which are respectively spaced apart from each other. The at least one non-conductive member 226 may be disposed between the plurality of conductive members. The plurality of conductive members may be disconnected from each other by the at least one non-conductive member 226 disposed between the plurality of conductive members. According to an embodiment, the plurality of conductive members and a plurality of non-conductive members may form an antenna radiator together. The electronic device 200 may communicate with an external electronic device through the antenna radiator formed by the plurality of conductive members and the plurality of non-conductive members.

The display 230 may be configured to display visual information. According to an embodiment, the display 230 may be disposed on the first surface 211 of the first housing 210 and the third surface 221 of the second housing 220 across the hinge structure 250. For example, the display 230 may include the first display region 231 disposed on the first surface 211 of a first housing, the second display region 232 disposed on the third surface 221 of a second housing, and a third display region 233 disposed between the first display region 231 and the second display region 232. The first display region 231, the second display region 232, and the third display region 233 may form a front surface of the display 230. According to an embodiment, the display 230 may further include a sub-display panel 235 disposed on the fourth surface 222 of the second housing 220. For example, the display 230 may be referred to as a flexible display. According to an embodiment, the display 230 may include a window exposed toward the outside of the electronic device 200. The window may protect a surface of the display 230 and transmit visual information provided by the display 230 to the outside of the electronic device 200, including a substantially transparent material. For example, the window may include glass (e.g., ultra-thin glass (UTG)) and/or polymer (e.g., polyimide (PI)), but is not limited thereto.

The at least one camera 240 may be configured to obtain an image based on receiving light from an external subject of the electronic device 200. According to an embodiment, the at least one camera 240 may include first cameras 241, a second camera 242, and a third camera 243. The first cameras 241 may be disposed in the first housing 210. For example, the first cameras 241 may be disposed inside the first housing 210, and at least some of them may be visible through the second surface 212 of the first housing 210. The first cameras 241 may be supported by a bracket (not illustrated) in the first housing 210. The first housing 210 may include at least one opening 241a overlapping the first cameras 241 when the second surface 212 is viewed from above. The first cameras 241 may obtain an image based on receiving light from the outside of the electronic device 200 through the at least one opening 241a.

According to an embodiment, the second camera 242 may be disposed in the second housing 220. For example, the second camera 242 may be disposed inside the second housing 220 and may be visible through the sub-display panel 235. The second housing 220 may include at least one opening 242a overlapping the second camera 242 when the fourth surface 222 is viewed from above. The second camera 242 may obtain an image based on receiving light from the outside of the electronic device 200 through the at least one opening 242a.

According to an embodiment, the third camera 243 may be disposed in the first housing 210. For example, the third camera 243 may be disposed inside the first housing 210, and at least a portion of it may be visible through the first surface 211 of the first housing 210. For another example, the third camera 243 may be disposed inside the first housing 210, and at least a portion of it may be visible through the first display region 231 of the display 230. The first display region 231 of the display 230 may include at least one opening (not illustrated) overlapping the third camera 243 when the display 230 is viewed from above. The third camera 243 may obtain an image based on receiving light from the outside of the display 230 through the at least one opening.

According to an embodiment, the second camera 242 and the third camera 243 may be disposed below the display 230 (e.g., in a direction toward inside of the first housing 210 or inside of the second housing 220). For example, the second camera 242 and the third camera 243 may be an under display camera (UDC). In a case that the second camera 242 and the third camera 243 are the under display cameras, a region of the display 230 corresponding to a position of each of the second camera 242 and the third camera 243 may not be an inactive region. For example, in a case that the second camera 242 and the third camera 243 are the under display cameras, the region of the display 230 corresponding to the positions of each of the second camera 242 and the third camera 243 may have a pixel density lower than that of another region of the display 230. The inactive region of the display 230 may mean a region of the display 230 that does not include a pixel or does not emit light to the outside of the electronic device 200. As another example, the second camera 242 and the third camera 243 may be a punch hole camera. In a case that the second camera 242 and the third camera 243 are the punch hole cameras, the region of the display 230 corresponding to the position of each of the second camera 242 and the third camera 243 may be an inactive region. For example, in a case that the second camera 242 and the third camera 243 are the punch hole cameras, the region of the display 230 corresponding to the position of each of the second camera 242 and the third camera 243 may include an opening that does not include a pixel.

According to an embodiment, the hinge structure 250 may rotatably connect the first housing 210 and the second housing 220. The hinge structure 250 may be disposed between the first housing 210 and the second housing 220 of the electronic device 101 such that the electronic device 200 may be bent, curved, or folded. For example, the hinge structure 250 may be disposed between a portion of the first side surface 213 and a portion of the second side surface 223 facing each other. The hinge structure 250 may change the electronic device 200 into an unfolding state in which a direction of the first surface 211 of the first housing 210 and the third surface 221 of the second housing 220 face is substantially the same as each other or a folding state in which the first surface 211 and the third surface 221 face each other. When the electronic device 200 is in the folded state, the first housing 210 and the second housing 220 may be stacked or overlapped by facing each other.

According to an embodiment, when the electronic device 200 is in the folded state, the direction in which the first surface 211 faces and the direction in which the third surface 221 faces may be different from each other. For example, when the electronic device 200 is in the folded state, the direction in which the first surface 211 faces and the direction in which the third surface 221 faces may be opposite to each other. For another example, when the electronic device 200 is in the folded state, the direction in which the first surface 211 faces and the direction in which the third surface 221 faces may be inclined with respect to each other. In a case that the direction in which the first surface 211 faces is inclined with respect to the direction in which the third surface 221 faces, the first housing 210 may be inclined with respect to the second housing 220.

According to an embodiment, the electronic device 200 may be foldable with respect to a folding axis f. The folding axis f may indicate an imaginary line parallel to a second direction (e.g., a +y direction). The folding axis f may mean an imaginary line extending through a hinge cover 251 in a direction (e.g., d1 of FIGS. 2A and 2B) substantially parallel to a longitudinal direction of the electronic device 200, but is not limited thereto. For example, the folding axis f may be an imaginary line extending in a direction (e.g., d2 of FIGS. 2A and 2B) substantially perpendicular to the longitudinal direction of the electronic device 200. In a case that the folding axis f extends in the direction substantially perpendicular to the longitudinal direction of the electronic device 200, the hinge structure 250 may connect the first housing 210 and the second housing 220 by extending in a direction parallel to the folding axis f. The first housing 210 and the second housing 220 may be rotatable by the hinge structure 250 extending in the direction substantially perpendicular to the longitudinal direction of the electronic device 200.

According to an embodiment, the hinge structure 250 may include the hinge cover 251, a first hinge plate 252, a second hinge plate 253, and a hinge module 254. The hinge cover 251 may cover internal components of the hinge structure 250 and form an outer surface of the hinge structure 250. According to an embodiment, when the electronic device 200 is in the folded state, at least a portion of the hinge cover 251 covering the hinge structure 250 may be exposed to the outside of the electronic device 200 through a space between the first housing 210 and the second housing 220. According to an embodiment, when the electronic device 200 is in the unfolded state, the hinge cover 251 may be covered by the first housing 210 and the second housing 220 and may not be exposed to the outside of the electronic device 200.

According to an embodiment, as the first hinge plate 252 and the second hinge plate 253 are coupled to the first housing 210 and the second housing 220, respectively, and may rotatably connect the first housing 210 and the second housing 220. For example, the first hinge plate 252 may be coupled to a first front bracket 215 of the first housing 210, and the second hinge plate 253 may be coupled to a second front bracket 227 of the second housing 220. As the first hinge plate 252 and the second hinge plate 253 are coupled to the first front bracket 215 and the second front bracket 227, respectively, the first housing 210 and the second housing 220 may be rotatable according to rotation of the first hinge plate 252 and the second hinge plate 253.

The hinge module 254 may rotate the first hinge plate 252 and the second hinge plate 253. For example, the hinge module 254 may rotate the first hinge plate 252 and the second hinge plate 253 with respect to the folding axis f, including gears that are engaged with each other and rotatable. According to an embodiment, the hinge module 254 may be plural. For example, the plurality of hinge modules 254 may be disposed to be spaced apart from each other at both ends of the first hinge plate 252 and the second hinge plate 253, respectively. However, it is not limited thereto. For example, the hinge structure 250 may further include a third hinge plate distinguished from the first hinge plate 252 and the second hinge plate 253. The third hinge plate may support the display 230. For example, a position of the third hinge plate may be fixed while the first hinge plate 252 and the second hinge plate 253 are moving. For example, the third hinge plate may be disposed between the first hinge plate 252 and the second hinge plate 253. In a case that the hinge structure 250 includes the third hinge plate, a distance between the first hinge plate 252 and the second hinge plate 253 may be greater than a size of the third hinge plate. For example, in a case that the hinge structure 250 includes the third hinge plate, it may be substantially the same as the distance between the first hinge plate 252 and the second hinge plate 253, the size of the third hinge plate, a size of a gap between the first hinge plate 252 and the third hinge plate, and a size of a gap between the second hinge plate 253 and the third hinge plate.

According to an embodiment, the first housing 210 may include the first front bracket 215 and a first rear bracket 216, and the second housing 220 may include the second front bracket 227 and a second rear bracket 228. The first front bracket 215 and the first rear bracket 216 may support components of the electronic device 200. The first front bracket 215 may define the first housing 210 by being coupled to the first rear bracket 216. The first rear bracket 216 may define a portion of an outer surface of the first housing 210. The second front bracket 227 and the second rear bracket 228 may support components of the electronic device 200. The second front bracket 227 may define the second housing 220 by being coupled to the second rear bracket 228. The second rear bracket 228 may define a portion of an outer surface of the second housing 220. For example, the display 230 may be disposed on a surface of the first front bracket 215 and a surface of the second front bracket 227. The first rear bracket 216 may be disposed on another surface of the first front bracket 215 opposite to the surface of the first front bracket 215. The second rear bracket 228 may be disposed on another surface of the second front bracket 227 opposite to the surface of the second front bracket 227. The sub-display panel 235 may be disposed between the second front bracket 227 and the second rear bracket 228.

According to an embodiment, a portion of the first front bracket 215 may be surrounded by the first side surface 213, and a portion of the second front bracket 227 may be surrounded by the second side surface 223. For example, the first front bracket 215 may be integrally formed with the first side surface 213, and the second front bracket 227 may be integrally formed with the second side surface 223. For another example, the first front bracket 215 may be formed separately from the first side surface 213, and the second front bracket 227 may be formed separately from the second side surface 223.

At least one electronic component 260 may implement various functions for providing to a user. According to an embodiment, the at least one electronic component 260 may include a first printed circuit board 261, a second printed circuit board 262, a flexible printed circuit board 263, a battery 264 (e.g., the battery 189 of FIG. 1), and/or an antenna 265 (e.g., the antenna module 197 of FIG. 1). Each of the first printed circuit board 261 and the second printed circuit board 262 may form an electrical connection of components in the electronic device 200. For example, components (e.g., the processor 120 of FIG. 1) for implementing an overall function of the electronic device 200 may be disposed on the first printed circuit board 261, and electronic components for implementing some functions of the first printed circuit board 261 may be disposed on the second printed circuit board 262. For another example, components for the operation of the sub-display panel 235 disposed on the fourth surface 222 may be disposed on the second printed circuit board 262.

According to an embodiment, the first printed circuit board 261 may be disposed in the first housing 210. For example, the first printed circuit board 261 may be disposed on the surface of the first front bracket 215. According to an embodiment, the second printed circuit board 262 may be disposed in the second housing 220. For example, the second printed circuit board 262 may be spaced apart from the first printed circuit board 261 and disposed on the surface of the second front bracket 227. The flexible printed circuit board 263 may connect the first printed circuit board 261 and the second printed circuit board 262. For example, the flexible printed circuit board 263 may extend from the first printed circuit board 261 to the second printed circuit board 262.

The battery 264 is a device for supplying power to at least one component of the electronic device 200, and may include, for example, a non-rechargeable primary battery, a rechargeable secondary battery, or a fuel cell. At least a portion of the battery 264 may be disposed on substantially the same plane as the first printed circuit board 261 or the second printed circuit board 262.

The antenna 265 may be configured to receive power or a signal from the outside of the electronic device 200. According to an embodiment, the antenna 265 may be disposed between the first rear bracket 216 and the battery 264. The antenna 265 may include, for example, a near field communication (NFC) antenna, an antenna module, and/or a magnetic secure transmission (MST) antenna. The antenna 265 may, for example, perform short-range communication with an external device or wirelessly transmit and receive power required for charging.

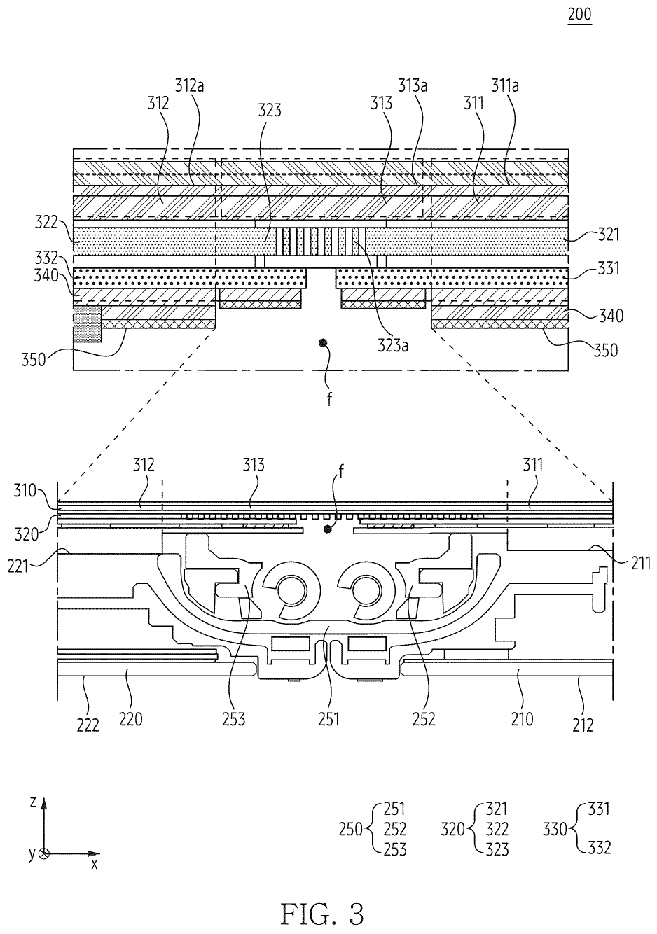

FIG. 3 is a cross-sectional view illustrating an example in which an electronic device is cut along line A-A′ of FIG. 2A according to an embodiment of the disclosure.

Referring to FIG. 3, an electronic device 200 according to an embodiment may include a first housing 210, a second housing 220, a hinge structure 250, a display 310 (e.g., the display 230 of FIGS. 2A, 2B, and 2C), a supporting plate 320, an electromagnetic sensor 330, a shielding sheet 340, and/or a conductive sheet 350.

According to an embodiment, the first housing 210 may support a portion of various components of the electronic device 200. The first housing 210 may be movable with respect to the second housing 220. For example, the first housing 210 may be rotatable with respect to the second housing 220. According to an embodiment, the first housing 210 may include a first surface 211 and a second surface 212. The first surface 211 may face the display 310. The second surface 212 may be opposite to the first surface 211. For example, the second surface 212 may be exposed to the outside of the first housing 210, but is not limited thereto.

According to an embodiment, the second housing 220 may support another portion of various components of the electronic device 200. The second housing 220 may be movable with respect to the first housing 210. For example, the second housing 220 may be rotatable with respect to the first housing 210. According to an embodiment, the second housing 220 may include a third surface 221 and a fourth surface 222. The third surface 221 may face the display 310. The fourth surface 222 may be opposite to the third surface 221. For example, the fourth surface 222 may be exposed to the outside of the second housing 220, but is not limited thereto.

According to an embodiment, the hinge structure 250 may movably connect the first housing 210 and the second housing 220. By the hinge structure 250, a state of the electronic device 200 may be changed from an unfolded state to a folded state or from the folded state to the unfolded state. In the unfolded state of the electronic device 200, a direction (e.g., a +z direction) in which the first surface 211 of the first housing 210 faces and a direction (e.g., the +z direction) in which the third surface 221 of the second housing 220 faces may be substantially the same as each other. By the movement of the second housing 220 with respect to the first housing 210, the state of the electronic device 200 may be changed from the unfolded state to the folded state. For example, as the first housing 210 rotates 90 degrees along a first rotational direction (e.g., counterclockwise in FIG. 3) with respect to the hinge structure 250 and the second housing 220 rotates 90 degrees along a second rotational direction (e.g., clockwise in FIG. 3) opposite to the first rotational direction, the state of the electronic device 200 may be changed from the unfolded state to the folded state. In the folded state of the electronic device 200, a direction (e.g., a −x direction) in which the first surface 211 of the first housing 210 faces may be opposite to a direction (e.g., a +x direction) in which the third surface 221 of the second housing 220 faces. For example, in the folded state of the electronic device 200, the first surface 211 of the first housing 210 may face the third surface 221 of the second housing 220. However, it is not limited thereto. For example, the state of the electronic device 200 may include an intermediate state that the direction in which the first surface 211 of the first housing 210 faces is inclined with respect to the direction in which the third surface 221 of the second housing 220 faces. The intermediate state may be referred to as a flex mode. By the movement of the second housing 220 with respect to the first housing 210, the state of the electronic device 200 may be changed from the folded state to the unfolded state. For example, as the first housing 210 rotates 90 degrees along the second rotational direction (e.g., clockwise in FIG. 3) with respect to the hinge structure 250 and the second housing 220 rotates 90 degrees along the first rotational direction (e.g., counterclockwise in FIG. 3), the state of the electronic device 200 may be changed from the unfolded state to the folded state. According to an embodiment, the hinge structure 250 may include a hinge cover 251, a first hinge plate 252, and/or a second hinge plate 253.

According to an embodiment, the hinge cover 251 may protect components of the hinge structure 250. The hinge cover 251 may be exposed to the outside of the electronic device 200 or may be covered by the first housing 210 and the second housing 220 according to a change in the state of the electronic device 200. For example, in the unfolded state of the electronic device 200, the hinge cover 251 may be covered by the first housing 210 and the second housing 220. For example, in the folded state of the electronic device 200, the hinge cover 251 may be exposed to the outside of the electronic device 200.

According to an embodiment, the first hinge plate 252 may fold or unfold the display 310 while the state of the electronic device 200 is changed. The first hinge plate 252 may be movable with respect to the hinge cover 251. For example, the first hinge plate 252 may be rotatable with respect to the hinge cover 251. The first hinge plate 252 may rotate while the first housing 210 rotates. For example, a rotational direction of the first hinge plate 252 may be substantially the same as a rotational direction of the first housing 210. According to an embodiment, a rotational angle of the first hinge plate 252 with respect to the hinge cover 251 while the state of the electronic device 200 is changed from the unfolded state to the folded state may be different from a rotational angle of the first housing 210 with respect to the hinge cover 251 while the state of the electronic device 200 is changed from the unfolded state to the folded state. For example, the rotational angle of the first hinge plate 252 with respect to the hinge cover 251 while the state of the electronic device 200 is changed from the unfolded state to the folded state may be greater than the rotational angle of the first housing 210 with respect to the hinge cover 251 while the state of the electronic device 200 is changed from the unfolded state to the folded state. For example, the first hinge plate 252 may rotate 100 degrees with respect to the hinge cover 251 while the state of the electronic device 200 is changed from the unfolded state to the folded state and the first housing 210 may rotate 90 degrees with respect to the hinge cover 251 while the state of the electronic device 200 is changed from the unfolded state to the folded state, but are not limited thereto. In the folded state of the electronic device 200, the first hinge plate 252 may be positioned to be inclined with respect to the first surface 211 of the first housing 210. However, it is not limited thereto. The rotational angle of the first hinge plate 252 with respect to the hinge cover 251 while the state of the electronic device 200 is changed from the unfolded state to the folded state may be substantially the same as the rotational angle of the first housing 210 with respect to the hinge cover 251 while the state of the electronic device 200 is changed from the unfolded state to the folded state. For example, in the unfolded state of the electronic device 200, the first hinge plate 252 may also be positioned to be substantially parallel to the first surface 211 of the first housing 210.

According to an embodiment, the second hinge plate 253 may fold or unfold the display 310 while the state of the electronic device 200 is changed. The second hinge plate 253 may be movable with respect to the hinge cover 251. For example, the second hinge plate 253 may be rotatable with respect to the hinge cover 251. The second hinge plate 253 may rotate while the second housing 220 rotates. For example, a rotational direction of the second hinge plate 253 may be substantially the same as a rotational direction of the second housing 220. According to an embodiment, a rotational angle of the second hinge plate 253 with respect to the hinge cover 251 while the state of the electronic device 200 is changed from the unfolded state to the folded state may be different from a rotational angle of the second housing 220 with respect to the hinge cover 251 while the state of the electronic device 200 is changed from the unfolded state to the folded state. For example, the rotational angle of the second hinge plate 253 with respect to the hinge cover 251 while the state of the electronic device 200 is changed from the unfolded state to the folded state may be greater than the rotational angle of the second housing 220 with respect to the hinge cover 251 while the state of the electronic device 200 is changed from the unfolded state to the folded state. For example, the second hinge plate 253 may rotate 100 degrees with respect to the hinge cover 251 while the state of the electronic device 200 is changed from the unfolded state to the folded state and the second housing 220 may rotate 90 degrees with respect to the hinge cover 251 while the state of the electronic device 200 is changed from the unfolded state to the folded state, but are not limited thereto. In the unfolded state of the electronic device 200, the second hinge plate 253 may be positioned to be substantially parallel to the third surface 221 of the second housing 220. In the folded state of the electronic device 200, the second hinge plate 253 may be positioned to be inclined with respect to the third surface 221 of the second housing 220. However, it is not limited thereto. The rotational angle of the second hinge plate 253 with respect to the hinge cover 251 while the state of the electronic device 200 is changed from the unfolded state to the folded state may be substantially the same as the rotational angle of the second housing 220 with respect to the hinge cover 251 while the state of the electronic device 200 is changed from the unfolded state to the folded state.

According to an embodiment, the display 310 may be configured to provide visual content. The display 310 may be disposed on the first surface 211 of the first housing 210 and the third surface 221 of the second housing 220 across the hinge structure 250. The display 310 may be deformable by the movement of the second housing 220 with respect to the first housing 210 and/or the movement of the first housing 210 with respect to the second housing 220. For example, the display 310 may be foldable with respect to a folding axis f by the movement of the second housing 220 with respect to the first housing 210 and/or the movement of the first housing 210 with respect to the second housing 220. For example, the display 310 may be foldable by the movement of the second housing 220 with respect to the first housing 210 and/or the movement of the first housing 210 with respect to the second housing 220. According to an embodiment, the display 310 may include a first planar part 311, a second planar part 312, and a folding part 313.

According to an embodiment, the first planar part 311 may be disposed (or aligned) on the first housing 210. For example, the first planar part 311 may be disposed on the first surface 211 of the first housing 210. For example, the first planar part 311 may be aligned on the first surface 211 of the first housing 210. For example, the first planar part 311 may be faced away from the first surface 211 of the first housing 210. The first planar part 311 may be flat. A shape of the first planar part 311 may be maintained while the state of the electronic device 200 is changed. For example, the first planar part 311 may have a shape substantially parallel to the first surface 211 of the first housing 210 in the folded state and/or the unfolded state of the electronic device 200.

According to an embodiment, the second planar part 312 may be disposed on the second housing 220. For example, the second planar part 312 may be disposed on the third surface 221 of the second housing 220. For example, the second planar part 312 may be faced away from the third surface 221 of the second housing 220. The second planar part 312 may be flat. A shape of the second planar part 312 may be maintained while the state of the electronic device 200 is changed. For example, the second planar part 312 may have a shape substantially parallel to the third surface 221 of the second housing 220 in the folded state and/or the unfolded state of the electronic device 200. According to an embodiment, the second planar part 312 may be spaced apart from the first planar part 311. For example, the second planar part 312 may be connected to the first planar part 311 by the folding part 313.

According to an embodiment, the folding part 313 may be disposed between the first planar part 311 and the second planar part 312. For example, the folding part 313 may be connected from the first planar part 311 to the second planar part 312. The folding part 313 may be disposed on the hinge structure 250. The folding part 313 may be deformable. A shape of the folding part 313 may be changed according to a change in the state of the electronic device 200. For example, the folding part 313 may be foldable with respect to the folding axis f by the movement of the second housing 220 with respect to the first housing 210 and/or the movement of the first housing 210 with respect to the second housing 220. For example, the folding part 313 may be foldable with respect to the folding axis f by movement of the second planar part 312 with respect to the first planar part 311 and/or movement of the first planar part 311 with respect to the second planar part 312. The folding part 313 may be unfolded in the unfolded state of the electronic device 200. The folding part 313 may be folded in the folded state of the electronic device 200. In the unfolded state of the electronic device 200, the folding part 313 may have a shape substantially parallel to the first planar part 311 and the second planar part 312. For example, in the unfolded state of the electronic device 200, the first planar part 311, the second planar part 312, and the folding part 313 may substantially define (or form) one plane. In the folded state of the electronic device 200, the folding part 313 may have a shape different from the first planar part 311 and the second planar part 312. For example, in the folded state of the electronic device 200, the folding part 313 may be curved to have a curvature. For example, the folding part 313 may be referred to as a deformation part.

According to an embodiment, in the unfolded state of the electronic device 200, a direction (e.g., the +z direction) in which a surface 311a of the first planar part 311 faces, a direction (e.g., the +z direction) in which a surface 312a of the second planar part 312 faces, and a direction (e.g., the +z direction) in which a surface 313a of the folding part 313 faces, may all be substantially the same. In the folded state of the electronic device 200, a direction (e.g., the −x direction) in which the surface 311a of the first planar part 311 faces may be opposite to a direction (e.g., the +x direction) in which the surface 312a of the second planar part 312 faces. For example, in the folded state of the electronic device 200, the surface 311a of the first planar part 311 may face the surface 312a of the second planar part 312.

According to an embodiment, a first plate 320 may support the display 310. The first plate 320 may protect the display 310 from an external force (or an impact) transmitted to the display 310. For example, the first plate 320 may be formed of at least one of stainless steel and/or carbon fiber reinforced plastic (CFRP), but is not limited thereto. The first plate 320 may be disposed below the display 310. The first plate 320 may be disposed on the first surface 211 of the first housing 210 and the third surface 221 of the second housing 220 across the hinge structure 250. The first plate 320 may be deformable while the state of the electronic device 200 is changed. According to an embodiment, the first plate 320 may include a first portion 321, a second portion 322, and/or a third portion 323.

According to an embodiment, the first portion 321 may be aligned with the first planar part 311. The first portion 321 may be disposed below the first planar part 311. The first portion 321 may be attached to the first planar part 311. The first portion 321 may be disposed (or interposed) between the first planar part 311 and the first surface 211 of the first housing 210. The first portion 321 may be faced away from the first surface 211 of the first housing 210. The first portion 321 may be flat. A shape of the first portion 321 may be maintained while the state of the electronic device 200 is changed. For example, the first portion 321 may have a shape substantially parallel to the first surface 211 in the folded state and/or the unfolded state of the electronic device 200.

According to an embodiment, the second portion 322 may be aligned with the second planar part 312. The second portion 322 may be disposed below the second planar part 312. The second portion 322 may be attached to the second planar part 312. The second portion 322 may be disposed (or interposed) between the second planar part 312 and the third surface 221 of the second housing 220. The second portion 322 may be faced away from the third surface 221 of the second housing 220. The second portion 322 may be flat. A shape of the second portion 322 may be maintained while the state of the electronic device 200 is changed. For example, the second portion 322 may have a shape substantially parallel to the first surface 211 in the folded state and/or the unfolded state of the electronic device 200. The second portion 322 may be spaced apart from the first portion 321. The second portion 322 may be connected to the first portion 321 by the third portion 323.

According to an embodiment, the third portion 323 may be disposed between the first portion 321 and the second portion 322. The third portion 323 may be disposed above the hinge structure 250. For example, the third portion 323 may be spaced apart from the hinge structure 250. The third portion 323 may be aligned with the folding part 313. The third portion 323 may correspond to the folding part 313. The third portion 323 may be deformable as the state of the electronic device 200 is changed The third portion 323 may be unfolded in the unfolded state of the electronic device 200 The third portion 323 may be positioned to be substantially parallel to the first portion 321 and the second portion 322 in the unfolded state of the electronic device 200. For example, the third portion 323 may substantially form (or define) one plane with the first portion 321 and the second portion 322 in the unfolded state of the electronic device 200. The third portion 323 may be curved to have a curvature with respect to the first portion 321 and the second portion 322 in the folded state of the electronic device 200. The third portion 323 may be folded in the folded state of the electronic device 200. According to an embodiment, the third portion 323 may include a plurality of openings 323a penetrating the third portion 323. The plurality of openings 323a may be spaced apart from each other. For example, the first plate 320 may have relative rigidity to protect the display 310. As the first plate 320 has relative rigidity, in a case that the third portion 323 does not include the plurality of openings 323a, a wrinkle due to stress generated by being folded and/or unfolded may be formed in the third portion 323. The electronic device 200 according to an embodiment may provide a structure in which damage to the first plate 320 protecting the display 310 may be reduced since the third portion 323 includes the plurality of openings 323a. For example, since a shape of the plurality of openings 323a is changed as the state of the electronic device 200 is changed, a wrinkle due to stress may not be formed in the third portion 323.

According to an embodiment, a thickness of the first portion 321, the second portion 322, and the third portion 323 may be substantially the same. A thickness of a component may indicate a distance in the direction (e.g., the +z direction) in which the first surface 211 faces in the unfolded state of the electronic device 200, and the corresponding expression may be utilized substantially the same below unless otherwise stated.

According to an embodiment, the electromagnetic sensor 330 may be configured to receive an input from an electronic pen. The electromagnetic sensor 330 may be configured to receive a hovering input or a touch input on the display 310. The electromagnetic sensor 330 may be referred to as an electromagnetic resonance (EMR) sensor, an electromagnetic inductive sensor, and/or a digitizer. According to an embodiment, the electromagnetic sensor 330 may be configured to transmit an electromagnetic signal to an electronic pen or receive an electromagnetic signal from the electronic pen. For example, the electromagnetic sensor 330 may transmit an electromagnetic signal to an electronic pen or receive the electromagnetic signal from the electronic pen. According to an embodiment, the electronic pen may be referred to as a stylus pen. For example, the electronic pen may have substantially the same shape as a shape of a pen. The electronic pen may be detachably coupled to the electronic device 200. For example, the electronic device 200 may include an accommodation space for accommodating an electronic pen p, and the electronic pen may be inserted (or accommodated) into the accommodation space. However, it is not limited thereto, and the electronic pen may be detachably coupled (or attached) to an outer surface of the electronic device 200.

According to an embodiment, the shielding sheet 340 may absorb an electromagnetic wave from the electromagnetic sensor 330. The shielding sheet 340 may be disposed below the supporting plate 320. For example, the shielding sheet 340 may be disposed (or attached) on a surface of the electromagnetic sensor 330 facing the first housing 210 and the second housing 220. For example, the shielding sheet 340 may include magnetic metal powder (MMP). The metal powder may include, for example, at least one selected from among iron, aluminum, nickel, silicon, or a combination thereof.

According to an embodiment, the conductive sheet 350 may reduce noise in the electromagnetic sensor 330. For example, the conductive sheet 350 may be formed of a conductive material (e.g., copper). The conductive sheet 350 may be disposed below the shielding sheet 340. For example, the conductive sheet 350 may be disposed (or attached) on a surface of the shielding sheet 340 facing the first housing 210 and the second housing 220. For example, the first housing 210 and the second housing 220 may be formed of different materials. For example, a portion of the first housing 210 may be formed of a conductive material, and the first housing 210 may be formed of a non-conductive material. Since materials forming the first housing 210 have different effects on the electromagnetic sensor 330, noise in the electromagnetic sensor 330 may increase in a case that the conductive sheet 350 is omitted. The electronic device 200 according to an embodiment may provide a structure capable of reducing noise in the electromagnetic sensor 330 due to materials forming the first housing 210 and the second housing 220 since the conductive sheet 350 is disposed below the electromagnetic sensor 330.

According to an embodiment, the electromagnetic sensor 330 may have a disconnected shape on the hinge structure 250. For example, the electromagnetic sensor 330 may include a first region 331 and a second region 332. The first region 331 and the second region 332 may be spaced apart from each other. In a case that the first region 331 and the second region 332 are disconnected from each other, the electronic device 200 may not easily identify a position of the electronic pen on the folding part 313. In a case that the first region 331 and the second region 332 are connected to each other, the electromagnetic sensor 330 may be damaged by stress generated as the state of the electronic device 200 is changed from the unfolded state to the folded state or from the folded state to the unfolded state. Hereinafter, a structure capable of easily identifying the position of the electronic pen while reducing the damage to the electromagnetic sensor 330 will be described.

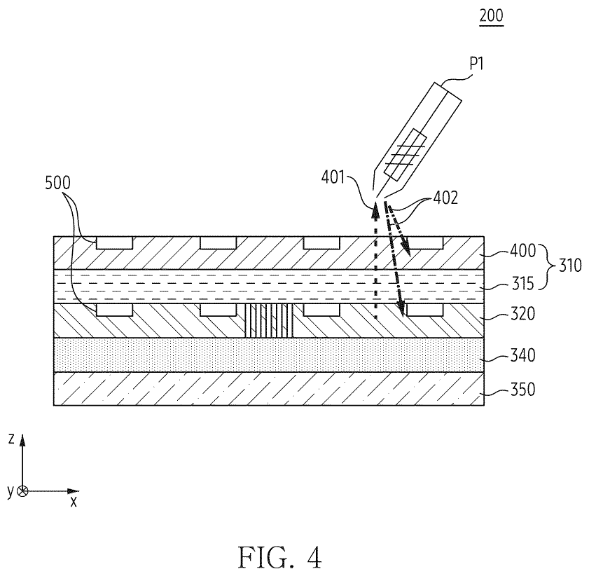

FIG. 4 indicates a relationship between a display, an electromagnetic sensor, and an electronic pen of an electronic device according to an embodiment of the disclosure.

For convenience of description, FIG. 4 only illustrates a display 310, a supporting plate 320, a touch sensor 400, and/or an electromagnetic sensor 500, but a component of an electronic device 200 is not limited thereto.

Referring to FIG. 4, according to an embodiment, the electronic device 200 may include the display 310, the supporting plate 320, the touch sensor 400, and/or the electromagnetic sensor 500.

According to an embodiment, the display 310 may include a light emitting layer 315. The light emitting layer 315 may be configured to emit light in a direction (e.g., a +z direction) toward the outside of the electronic device 200. The light emitting layer 315 may define (or include) a plurality of pixels of the display 300. For example, the light emitting layer 315 may be referred to as a pixel layer.

According to an embodiment, the touch sensor 400 may be configured to receive a touch input on the display 310. The touch sensor 400 may be disposed in the display 310. For example, the touch sensor 400 may be included in the display 310. For example, the touch sensor 400 may be integrally formed with the display 310. According to an embodiment, the touch sensor 400 may be disposed on the light emitting layer 315. The touch sensor 400 may include a plurality of electrodes. For example, the plurality of electrodes of the touch sensor 400 may overlap a plurality of pixels of the light emitting layer 315, but are not limited thereto. For example, the plurality of electrodes of the touch sensor 400 may not overlap the plurality of pixels in the light emitting layer 315. For example, the plurality of electrodes of the touch sensor 400 may also be disposed between the plurality of pixels in the light emitting layer 315

According to an embodiment, the electromagnetic sensor 500 may obtain data for identifying a position of an electronic pen p1 on the display 310. For example, the electromagnetic sensor 500 may include a plurality of coils for transmitting an electromagnetic signal toward the outside of the electronic device 200 or receiving an electromagnetic signal transmitted from the outside of the electronic device 200. The electronic device 200 may transmit a first signal 401 to the electronic pen p1 through the plurality of coils of the electromagnetic sensor 500. For example, in the electronic device 200, the first signal 401 received at the electronic pen p1 may cause an electromagnetic resonance in the electronic pen p1. For example, the first signal 401 may cause electromagnetic induction in a coil (not illustrated) included in the electronic pen p1. An electromagnetic wave generated by the electromagnetic resonance in the electronic pen p1 may be transmitted to the electromagnetic sensor 500. By the electromagnetic induced current in the electronic pen p1, the electronic pen p1 may generate an electromagnetic wave without separately supplying power. Based on the electromagnetic induced current in the coil, the electronic pen p1 may generate an electromagnetic wave and transmit the generated electromagnetic wave to the electromagnetic sensor 500. The electromagnetic sensor 500 may obtain a second signal 402 caused by the electromagnetic wave from the electronic pen p1 based on receiving the electromagnetic wave from the electronic pen p1. The second signal 402 may be obtained based on the electromagnetic wave from the electronic pen p1 causing an electromagnetic resonance to the plurality of coils of the electromagnetic sensor 500. The electronic device 200 may identify an input from the electronic pen p1 based on the second signal 402 generated by the electromagnetic resonance in the electromagnetic sensor 500.

According to an embodiment, the electronic device 200 may identify a type of the input from the electronic pen p1 based on identifying a phase of the second signal 402. For example, the electronic device 200 may identify the input from the electronic pen p1 as a touch input based on identifying that the phase of the second signal 402 is equal to or less than a first threshold value. For example, the electronic device 200 may identify the input from the electronic pen p1 as a hovering input based on identifying that the phase of the second signal 402 exceeds the first threshold value. According to an embodiment, the electronic device 200 may identify data related to the position of the electronic pen p1 based on an intensity of the second signal 402. For example, the data related to the position of the electronic pen p1 may include coordinates on the display 310 corresponding to a position of the electronic pen p1 above the display 310.

According to an embodiment, the plurality of coils of the electromagnetic sensor 500 may include a first group of conductive patterns and a second group of conductive patterns crossing each other. A portion of the electromagnetic sensor 500 may be disposed in the touch sensor 400. The portion of the electromagnetic sensor 500 may be formed (or defined) in the touch sensor 400. For example, the first group of conductive patterns of the electromagnetic sensor 500 may be disposed in the touch sensor 400. Another portion of the electromagnetic sensor 500 may be disposed on the supporting plate 320. For example, the other portion of the electromagnetic sensor 500 may be formed (or defined) on the supporting plate 320. For example, the second group of conductive patterns of the electromagnetic sensor 500 may be disposed on the supporting plate 320. A disposition relationship of the plurality of coils of the electromagnetic sensor 500 may be described in detail below.

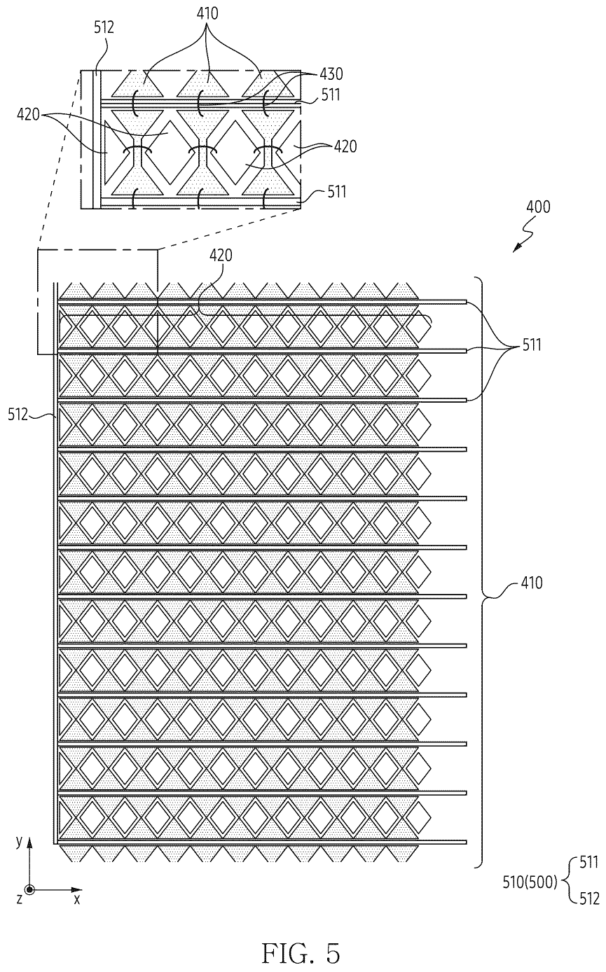

FIG. 5 is a top view of a touch sensor of an electronic device according to an embodiment of the disclosure.

Referring to FIG. 5, according to an embodiment, a touch sensor 400 may include a plurality of first electrodes 410 and a plurality of second electrodes 420. For example, the touch sensor 400 may be configured to receive a touch input based on capacitance of the plurality of first electrodes 410 and the plurality of second electrodes 420. For example, the plurality of first electrodes 410 and the plurality of second electrodes 420 may be substantially transparent such that light from pixels of a display (e.g., the display 310 of FIG. 3) is easily emitted to the outside. For example, the plurality of first electrodes 410 and the plurality of second electrodes 420 may be formed of indium tin oxide (ITO).

According to an embodiment, each of the plurality of first electrodes 410 may extend in a first direction (e.g., a +x direction). The plurality of first electrodes 410 may be arranged (or aligned) in a second direction (e.g., a +y direction) crossing the first direction. For example, the plurality of first electrodes 410 may be formed along the second direction (e.g., the +y direction). The plurality of first electrodes 410 may be utilized to identify a touch position in the second direction (e.g., the +y direction). For example, the plurality of first electrodes 410 may be referred to as a plurality of first conductive patterns.

According to an embodiment, the plurality of second electrodes 420 may be arranged (or aligned) in the first direction (e.g., the +x direction). Each of the plurality of second electrodes 420 may extend in the second direction (e.g., the +y direction) crossing the first direction. For example, the plurality of second electrodes 420 may be formed along the first direction (e.g., the +x direction). The plurality of second electrodes 420 may be utilized to identify a touch position in the first direction (e.g., the +x direction). For example, the plurality of second electrodes 420 may be referred to as a plurality of second conductive patterns.

According to an embodiment, an electromagnetic sensor 500 may include a first group of conductive patterns 510.

According to an embodiment, the first group of conductive patterns 510 may be utilized to identify a position of an electronic pen (e.g., the electronic pen p1 of FIG. 4) in the second direction (e.g., the +y direction). Each of the first group of conductive patterns 510 may extend in the first direction (e.g., the +y direction). The first group of conductive patterns 510 may be arranged (or aligned) in the second direction (e.g., the +y direction) crossing the first direction. For example, the first group of conductive patterns 510 may be formed along the second direction (e.g., the +y direction). The first group of conductive patterns 510 may be referred to as a plurality of third electrodes. For example, the first group of conductive patterns 510 may be substantially transparent such that light from pixels of the display 310 is easily emitted to the outside. For example, the first group of conductive patterns 510 may be formed of indium tin oxide (ITO). However, it is not limited thereto. For example, the first group of conductive patterns 510 may have a mesh shape. In a case that the first group of conductive patterns 510 has the mesh shape, the first group of conductive patterns 510 may be arranged to bypass pixels in a light emitting layer 315. According to an embodiment, the first group of conductive patterns 510 may have a loop shape. For example, each of the first group of conductive patterns 510 may be formed as conductive lines (or conductive patterns) are curved to have the loop shape. For example, the loops formed by each of the first group of conductive patterns 510 may have a shape connected to each other. However, it is not limited thereto. For example, the loops formed by each of the first group of conductive patterns 510 may also be spaced apart from each other. A second signal caused by an electromagnetic wave received from the electronic pen p1 may be received by the electromagnetic sensor 500 through the first group of conductive patterns 510.

According to an embodiment, the first group of conductive patterns 510 may be disposed on a single layer with the plurality of first electrodes 410 and the plurality of second electrodes 420, but are not limited thereto. For example, at least one of the first group of conductive patterns 510, the plurality of first electrodes 410, and the plurality of second electrodes 420 may be disposed on another layer with another one. For example, the first group of conductive patterns 510 may include a plurality of first conductive patterns 511 and at least one second conductive line 512.

According to an embodiment, the plurality of first conductive patterns 511 may form the first group of conductive patterns 510. The plurality of first conductive patterns 511 may be arranged to be spaced apart from each other. For example, the plurality of first conductive patterns 511 may be spaced apart from each other along the second direction (e.g., the +y direction). The plurality of first conductive patterns 511 may have a linearly extended shape. For example, the plurality of first conductive patterns 511 may have a shape extended along the first direction (e.g., the +x direction) According to an embodiment, the plurality of first conductive patterns 511 may penetrate at least one of the plurality of first electrodes 410 and the plurality of second electrodes 420. For example, the plurality of first conductive patterns 511 may penetrate each of the plurality of first electrodes 410 to cross the plurality of first electrodes 410. The plurality of first electrodes 410 penetrated by each of the plurality of first conductive patterns 511 may be electrically connected by a plurality of connection lines 430 of the touch sensor 400.

On the other hand, as illustrated in FIG. 5 as another embodiment, first electrodes 610 may penetrate first conductive lines 611, and the plurality of penetrated first conductive lines 611 may be electrically connected by a plurality of connection lines 630.

According to an embodiment, the plurality of first electrodes 410 and the plurality of second electrodes 420 may be spaced apart from the first group of conductive patterns 510. For example, the plurality of first conductive patterns 511 defining the first group of conductive patterns 510 may be disposed between the plurality of first electrodes 410. For example, the plurality of first conductive patterns 511 may not overlap the plurality of first electrodes 410 by being spaced apart from the plurality of first electrodes 410 between the plurality of first electrodes 410.

According to an embodiment, the at least one second conductive line 512 may electrically (or physically) connect the plurality of first conductive patterns 511. For example, the at least one second conductive line 512 may be connected to an end of each of the plurality of first conductive patterns 511. For example, the at least one second conductive line 512 may extend in the first direction (e.g., the +x direction) to connect the plurality of first conductive patterns 511. Since the first group of conductive patterns 510 shares the plurality of first conductive patterns 511 defining (or forming) each of the first group of conductive patterns 510, it may be arranged to be adjacent to each other.

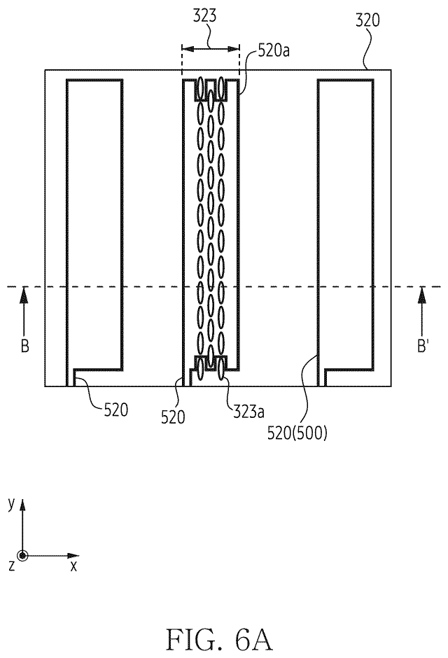

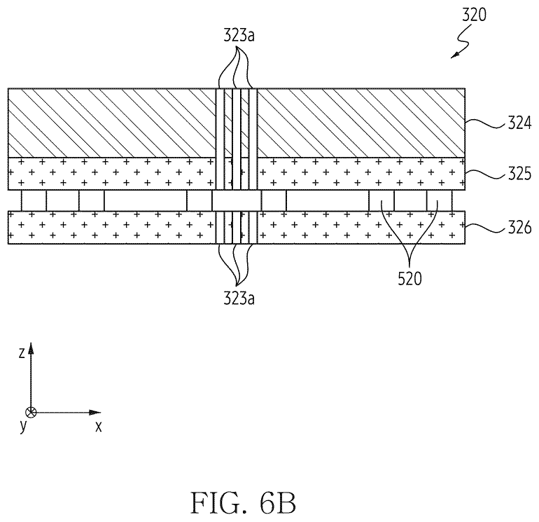

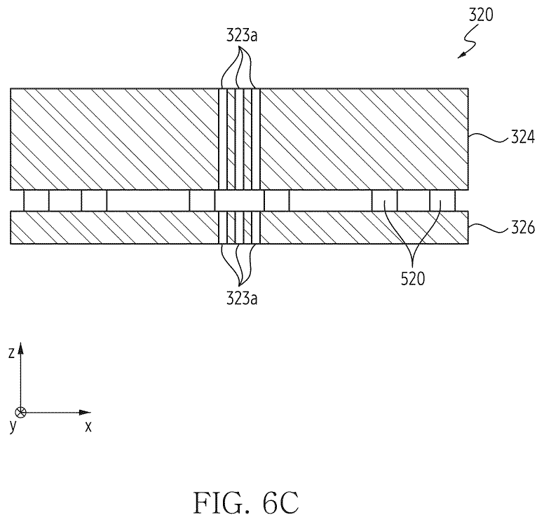

FIG. 6A is a top view of a supporting plate and electromagnetic sensor, according to an embodiment of the disclosure. FIG. 6B is a cross-sectional view illustrating an example in which a supporting plate and electromagnetic sensor are cut along line B-B′ of FIG. 6A according to an embodiment of the disclosure. FIG. 6C is a cross-sectional view illustrating an example of cutting a supporting plate and electromagnetic sensor, according to an embodiment of the disclosure.

Referring to FIGS. 6A, 6B, and 6C, according to an embodiment, an electromagnetic sensor 500 may include a second group of conductive patterns 520.

According to an embodiment, the second group of conductive patterns 520 may be utilized to identify a position of an electronic pen (e.g., the electronic pen p1 of FIG. 4) in a first direction (e.g., a +x direction). Each of the second group of conductive patterns 520 may extend along a second direction (e.g., a +y direction) crossing the first direction. The second group of conductive patterns 520 may be arranged (or aligned) in the first direction (e.g., the +x direction). For example, the second group of conductive patterns 520 may be formed along the first direction (e.g., the +x direction). The second group of conductive patterns 520 may be referred to as a plurality of third electrodes. According to an embodiment, the second group of conductive patterns 520 may have a loop shape. For example, each of the second group of conductive patterns 520 may be formed as conductive lines (or conductive patterns) are curved to have the loop shape. For example, the loops formed by each of the second group of conductive patterns 520 may be spaced apart from each other. However, it is not limited thereto. For example, the loops formed by each of the second group of conductive patterns 520 may have a shape connected to each other. A second signal caused by an electromagnetic wave received from the electronic pen p1 may be received by the electromagnetic sensor 500 through the second group of conductive patterns 520

According to an embodiment, the second group of conductive patterns 520 may be disposed on (or in) a supporting plate 320. For example, the second group of conductive patterns 520 may be formed on (or in) the supporting plate 320. For example, the second group of conductive patterns 520 may be disposed to be spaced apart from each other on (or in) the supporting plate 320, but are not limited thereto. For example, the second group of conductive patterns 520 may be disposed to overlap each other on (or in) the supporting plate 320. Since the second group of conductive patterns 520 is disposed on (or in) the supporting plate 320 disposed below a display (e.g., the display 310 of FIG. 3), the second group of conductive patterns 520 may be opaque. For example, the second group of conductive patterns 520 may be formed of opaque metal.

According to an embodiment, the second group of conductive patterns 520 may be disposed below a center of the supporting plate 320. For example, the center of the supporting plate 320 may indicate a center of a thickness of the supporting plate 320. Referring to FIG. 6B, the supporting plate 320 may include a first layer 324, a second layer 325, and/or a third layer 326. The first layer 324 may protect the second layer 325, the third layer 326, and the second group of conductive patterns 520. For example, the first layer 324 may be disposed above the second layer 325. For example, the first layer 324 may be formed of a carbon fiber reinforced plate (CFRP), but is not limited thereto. For example, a plurality of openings 323a may penetrate the first layer 324, the second layer 325, and/or the third layer 326. The second layer 325 may be disposed below the first layer 324. For example, the second layer 325 may be formed of an insulating material. The third layer 326 may be disposed below the second layer 325. For example, the second group of conductive patterns 520 may be disposed (or interposed) between the second layer 325 and the third layer 326, but are not limited thereto. For example, the third layer 326 may be formed of an insulating material. However, it is not limited thereto. For example, referring to FIG. 6C, the supporting plate 320 may include the first layer 324 and/or the third layer 326. The first layer 324 and the third layer 326 may protect the second group of conductive patterns 520. For example, the first layer 324 may be disposed above the third layer 326. For example, the first layer 324 may be formed of a glass fiber reinforced plate (GFRP), but is not limited thereto. For example, the plurality of openings 323a may penetrate the first layer 324 and/or the third layer 326. The third layer 326 may be formed of substantially the same material as the first layer 324. For example, the third layer 326 may be formed of a glass fiber reinforced plastic (GFRP), but is not limited thereto. The second group of conductive patterns 520 may be disposed (or interposed) between the first layer 324 and the third layer 326. For example, a thickness of the third layer 326 may be thinner than a thickness of the first layer 324. Since the thickness of the third layer 326 is relatively thinner than the thickness of the first layer 324, the second group of conductive patterns 520 positioned between the third layer 326 and the first layer 324 may be positioned below the center of the supporting plate 320.

According to an embodiment, a first coil 520a of the second group of conductive patterns 520 may be disposed on a third portion 323. The first coil 520a may be aligned with the third portion 323. For example, the first coil 520a may be aligned with a folding part (e.g., the folding part 313 of FIG. 3) of the display 310. A portion of the first coil 520a may pass through between the plurality of openings 323a. For example, the portion of the first coil 520a may have a curved shape between the plurality of openings 323a to bypass the plurality of openings 323a.

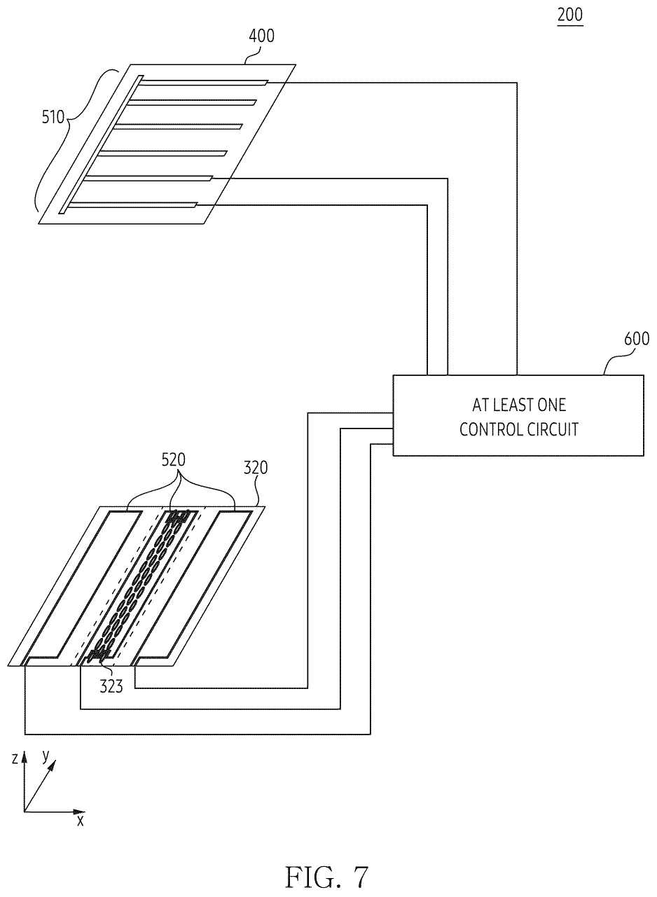

FIG. 7 indicates a relationship between an electromagnetic sensor, touch sensor, and supporting plate, according to an embodiment of the disclosure.

Referring to FIG. 7, according to an embodiment, since a first group of conductive patterns 510 is disposed above a plurality of pixels of a display (e.g., the display 310 of FIG. 3), and a second group of conductive patterns 520 is disposed below the plurality of pixels of the display 310, the first group of conductive patterns 510 and the second group of conductive patterns 520 may overlap each other. The first group of conductive patterns 510 and the second group of conductive patterns 520 may overlap to cross each other.

According to an embodiment, an electronic device 200 may further include at least one control circuit 600. The at least one control circuit 600 may include at least one processor configured to execute instructions stored in memory. The at least one control circuit 600 may control an electromagnetic sensor 500. For example, the at least one control circuit 600 may obtain data for identifying a position of an electronic pen (e.g., the electronic pen p1 of FIG. 4) through the electromagnetic sensor 500. The at least one control circuit 600 may identify a position of the electronic pen p1 on the display (e.g., the display 310 of FIG. 3) based on the data. The at least one control circuit 600 may be electrically connected to the first group of conductive patterns 510 and the second group of conductive patterns 520. The at least one control circuit 600 may be operatively coupled to the first group of conductive patterns 510 and the second group of conductive patterns 520. For example, the at least one control circuit 600 may be referred to as a digitizer IC.

According to an embodiment, the at least one control circuit 600 may be configured to transmit a first signal for an electromagnetic resonance in the electronic pen p1 to the electronic pen p1 through at least one of the first group of conductive patterns 510 and the second group of conductive patterns 520. In order to transmit the first signal for inducing the electromagnetic resonance in the electronic pen p1 to the electronic pen p1, the at least one control circuit 600 may be configured to provide power to at least one of the first group of conductive patterns 510 and the second group of conductive patterns 520. For example, the at least one control circuit 600 may be configured to transmit the first signal to the electronic pen p1 through the second group of conductive patterns 520 of the first group of conductive patterns 510 and the second group of conductive patterns 520. For example, the at least one control circuit 600 may be configured to provide power to the second group of conductive patterns 520 of the first group of conductive patterns 510 and the second group of conductive patterns 520 to transmit the first signal to the electronic pen p1. For example, in order for the display (e.g., the display 310 of FIG. 3) to be folded, a width of the first group of conductive patterns 510 may be narrower than a width of the second group of conductive patterns 520. For example, the width of the second group of conductive patterns 520 may be equal to or greater than 10 μm. Since the width of the first group of conductive patterns 510 are narrower than the width of the second group of conductive patterns 520, resistance of the first group of conductive patterns 510 may be relatively greater than resistance of the second group of conductive patterns 520. The electronic device 200 according to an embodiment may provide a structure capable of minimizing power waste since it emits the first signal toward the electronic pen p1 through the second group of conductive patterns 520 having a relatively small resistance.

According to an embodiment, the at least one control circuit 600 may be configured to receive a second signal from the electronic pen p1 for identifying a position from the electronic pen p1 caused by the first signal through the first group of conductive patterns 510 and the second group of conductive patterns 520. For example, the at least one control circuit 600 may be configured to identify a position of the electronic pen p1 in a second direction (e.g., a +y direction) through the first group of conductive patterns 510. Since an intensity of a current (or a voltage) caused by a portion of the first group of conductive patterns 510 corresponding to a position of the electronic pen p1 is greater than an intensity of a current (or a voltage) received by another portion of the first group of conductive patterns 510, the at least one control circuit 600 may identify the position of the electronic pen p1 based on identifying the portion of the first group of conductive patterns 510 arranged in the second direction (e.g., the +y direction) to which a relatively large current (or voltage) is applied. For example, the at least one control circuit 600 may identify a position of the electronic pen p1 by amplifying magnitude of a current (or a voltage) applied to the first group of conductive patterns 510 through differential amplifiers connected to each of the first group of conductive patterns 510. For example, the at least one control circuit 600 may be configured to identify a position of the electronic pen p1 in a first direction (e.g., a +x direction) through the second group of conductive patterns 520. Since an intensity of a current (or a voltage) caused at a portion of the second group of conductive patterns 520 corresponding to a position of the electronic pen p1 is greater than an intensity of a current (or a voltage) received by another portion of the second group of conductive patterns 520, the at least one control circuit 600 may identify the position of the electronic pen p1 based on identifying the portion of the second group of conductive patterns 520 arranged in the first direction (e.g., the +x direction) to which a relatively large current (or voltage) is applied. For example, the at least one control circuit 600 may identify a position of the electronic pen p1 by amplifying magnitude of a current (or a voltage) applied to the second group of conductive patterns 520 through differential amplifiers connected to each of the second group of conductive patterns 520.

According to an embodiment, the at least one control circuit 600 may be configured to transmit the first signal to the electronic pen through the second group of conductive patterns 520 during a first time section. The at least one control circuit 600 may be configured to identify a position of the electronic pen p1 through the first group of conductive patterns 510 and the second group of conductive patterns 520 based on receiving the second signal after the first time section is elapsed. For example, the at least one control circuit 600 may be configured to identify a position of the electronic pen p1 in the first direction (e.g., the +x direction) through the second group of conductive patterns 520 during a second time section based on receiving the second signal after the first time section is elapsed. During the second time section, a time after the first time section may be indicated. For example, a length of the second time section may be substantially the same as or different from a length of the first time section. For example, the at least one control circuit 600 may be configured to identify a position of the electronic pen p1 in the second direction (e.g., the +y direction) through the first group of conductive patterns 510 during a third time section after the second time section is elapsed. During the third time section, a time after the first time section may be indicated. For example, a length of the third time section may be substantially the same as or different from the length of the first time section. However, it is not limited thereto. For example, the at least one control circuit 600 may be configured to identify a position of the electronic pen p1 in the second direction (e.g., the +y direction) through the first group of conductive patterns 510 during the second time section based on receiving the second signal after the first time section is elapsed, and identify a position of the electronic pen p1 in the first direction (e.g., the +x direction) through the second group of conductive patterns 520. For example, the at least one control circuit 600 may be configured to identify a position of the electronic pen p1 in the second direction (e.g., the +y direction) through the first group of conductive patterns 510 during the second time section based on receiving the second signal after the first time section is elapsed. For example, the at least one control circuit 600 may be configured to identify a position of the electronic pen p1 in the first direction (e.g., the +x direction) through the second group of conductive patterns 520 during the third time section after the second time section is elapsed.

As described above, the electronic device 200 according to an embodiment may provide a structure capable of reducing damage to the electromagnetic sensor 500 through the first group of conductive patterns 510 and the second group of conductive patterns 520 divided and disposed in a touch sensor 400 and a supporting plate 320, respectively. For example, since the first group of conductive patterns 510 and the second group of conductive patterns 520 are divided and disposed, stress caused at the electromagnetic sensor 500 may be relatively dispersed. Since the stress caused at the electromagnetic sensor 500 may be relatively dispersed, damage to the electromagnetic sensor 500 due to stress according to a change in a state of the electronic device 200 may be reduced. Since the damage to the electromagnetic sensor 500 is reduced, the second group of conductive patterns 520 may be disposed on a third portion 323 of the supporting plate 320 corresponding to a folding part (e.g., the folding part 313 of FIG. 3). Since the second group of conductive patterns 520 is disposed on the third portion 323, the electronic device 200 (or the at least one control circuit 600) may easily identify a position of the electronic pen p1 on the folding part 313.

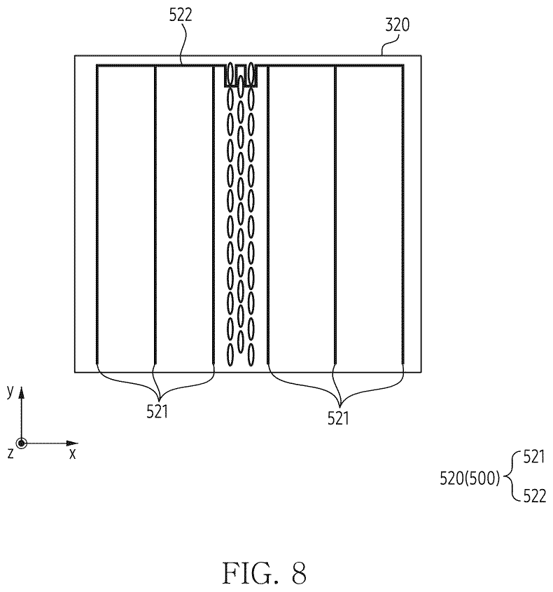

Meanwhile, in FIGS. 6A and 7, it is illustrated that each of the second group of conductive patterns 520 forms loops spaced apart from each other, but it is not limited thereto. For example, each of the second group of conductive patterns 520 may be disposed adjacent to each other. A structure in which each of the second group of conductive patterns 520 is adjacent may be described through FIG. 8.

FIG. 8 is a top view of a supporting plate and electromagnetic sensor, according to an embodiment of the disclosure.

Referring to FIG. 8, according to an embodiment, a second group of conductive patterns 520 may include a plurality of third conductive patterns 521 and at least one fourth conductive pattern 522.

According to an embodiment, the plurality of third conductive patterns 521 may form the second group of conductive patterns 520. The plurality of third conductive patterns 521 may extend linearly. The plurality of third conductive patterns 521 may have a shape extended in a second direction (e.g., a +y direction). For example, the plurality of third conductive patterns 521 may extend along the second direction (e.g., the +y direction) substantially parallel to a folding axis (e.g., the folding axis f of FIG. 3). The plurality of third conductive patterns 521 may be spaced apart from each other. For example, the plurality of third conductive patterns 521 may be arranged to be spaced apart from each other along a first direction (e.g., a +x direction).

According to an embodiment, the at least one fourth conductive pattern 522 may form the second group of conductive patterns 520. The at least one fourth conductive pattern 522 may electrically (or physically) connect a plurality of second conductive patterns 521. For example, the at least one fourth conductive pattern 522 may be connected to an end of each of the plurality of second conductive patterns 521. For example, the at least one fourth conductive pattern 522 may extend in the first direction (e.g., the +x direction) to connect the plurality of second conductive patterns 521. Since the second group of conductive patterns 520 shares the plurality of third conductive patterns 521 defining (or forming) each of the second group of conductive patterns 520, it may be arranged to be adjacent to each other.

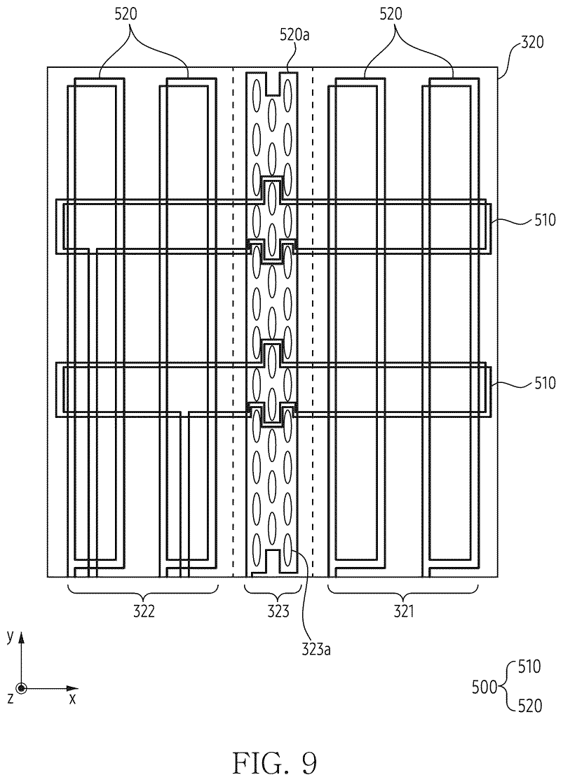

FIG. 9 is a top view of a supporting plate according to an embodiment of the disclosure.

Referring to FIG. 9, according to an embodiment, each of a first group of conductive patterns 510 and a second group of conductive patterns 520 of an electromagnetic sensor 500 may be disposed (or formed) on a supporting plate 320. For example, the first group of conductive patterns 510 may be arranged along a second direction (e.g., a +y direction) on the supporting plate 320. For example, the second group of conductive patterns 520 may be arranged along a first direction (e.g., a +x direction) on the supporting plate 320.

According to an embodiment, each of the first group of conductive patterns 510 may be disposed on a first portion 321 and a second portion 322 across a third portion 323 of the supporting plate 320 corresponding to a folding part (e.g., the folding part 313 of FIG. 3). A portion of each of the first group of conductive patterns 510 may be curved to bypass a plurality of openings 323a formed in the third portion 323. For example, the portion of each of the first group of conductive patterns 510 may not overlap the plurality of openings 323a formed in the third portion 323.

According to an embodiment, among the second group of conductive patterns 520, a first coil 520a disposed on the third portion 323 of the supporting plate 320 may surround the plurality of openings 323a. For example, the first coil 520a may be disposed along a periphery of a region of the third portion 323 in which the plurality of openings 323a are formed.

According to an embodiment, the number of turns of a coil among the second group of conductive patterns 520 may be different from the number of turns of another coil of the second group of conductive patterns 520. For example, the number of turns of the first coil 520a among the second group of conductive patterns 520 may be smaller than the number of turns of another coil. For example, the number of turns of the first coil 520a may be one, and the number of turns of another coil among the second group of conductive patterns 520 may be two or more, but are not limited thereto. Since the number of turns of the first coil 520a corresponding to the folding part 313 is relatively small, damage to the second group of conductive patterns 520 due to stress may be reduced. However, it is not limited thereto. For example, among the second group of conductive patterns 520, the number of turns of a coil disposed along at least a portion of a periphery of the supporting plate 320 may be smaller than the number of turns of another coil. For example, among the second group of conductive patterns 520, the number of turns of a coil disposed along at least a portion of a periphery of the first portion 321 of the supporting plate 320 may be smaller than the number of turns of another coil disposed in the first portion 321. For example, among the second group of conductive patterns 520, the number of turns of a coil disposed along at least a portion of a periphery of the second portion 322 of the supporting plate 320 may be smaller than the number of turns of another coil disposed in the second portion 322.

As described above, an electronic device (e.g., the electronic device 200 of FIG. 4) according to an embodiment may provide a structure capable of reducing damage to the electromagnetic sensor 500 due to stress through the first group of conductive patterns 510 and the second group of conductive patterns 520 formed to cross each other on the supporting plate 320.

The electronic device may include a sensor for receiving an input from an electronic pen distinguished from the electronic device. For example, the electronic device may include an electromagnetic sensor configured to identify a position of the electronic pen on the electronic device through an electromagnetic signal received from the electronic pen, based on causing an electromagnetic induction resonance in the electronic pen. In a case that housings of the electronic device are movable with respect to each other to change a shape of a display, the sensor may be damaged by stress according to movement of the housings. In a case that the electromagnetic sensor has a shape in which the electromagnetic sensor is disconnected to reduce the damage due to the stress, the sensor may not easily identify a position of the electronic pen. The electronic device may require a structure capable of accurately identifying the position of the electronic pen while reducing damage to the sensor.

An electronic device (e.g., the electronic device 200 of FIG. 4) is provided. According to an embodiment, the electronic device may include a display (e.g., the display 310 of FIG. 3) including a first planar part (e.g., the first planar part 311 of FIG. 3), a second planar part (e.g., the second planar part 312 of FIG. 3), and a folding part (e.g., the folding part 313 of FIG. 3) disposed between the first planar part and the second planar part and foldable. According to an embodiment, the electronic device may include a touch sensor (e.g., the touch sensor 400 of FIG. 4) for receiving a touch input from outside of the electronic device and disposed in the display. According to an embodiment, the electronic device may include a supporting plate (e.g., the supporting plate 320 of FIG. 3) supporting the display and including a plurality of openings aligned with the folding part. According to an embodiment, the electronic device may include a first group of conductive patterns (e.g., the first group of conductive patterns 510 of FIG. 5) disposed in the touch sensor and respectively extending in a first direction and a second group of conductive patterns (e.g., the second group of conductive patterns 520 of FIG. 6A) disposed on the supporting plate and respectively extending along a second direction crossing the first direction. According to an embodiment, the electronic device may include at least one control circuit (e.g., the at least one control circuit 600 of FIG. 7). According to an embodiment, the at least one control circuit may be configured to transmit a first signal, for inducing an electromagnetic resonance, to an electronic pen through at least one of the first group of conductive patterns and the second group of conductive patterns. According to an embodiment, the at least one control circuit may be configured to receive a second signal from the electronic pen, for identifying a position of the electronic pen, caused by the first signal, through the first group of conductive patterns and the second group of conductive patterns.

The electronic device according to an embodiment may provide a structure that may easily identify the position of the electronic pen positioned on the folding part while reducing damage to an electromagnetic sensor due to stress resulting from being folded or unfolded of the display, since the first group of conductive patterns and the second group of conductive patterns of the electromagnetic sensor are distributed and disposed.

According to an embodiment, the at least one control circuit may be configured to transmit the first signal to the electronic pen through the second group of conductive patterns of the first group of conductive patterns and the second group of conductive patterns.

Since the electronic device according to an embodiment transmits the first signal to the electronic pen through the second group of conductive patterns having a relatively low resistance, waste of power may be reduced.

According to an embodiment, a width of the first group of conductive patterns may be narrower than a width of the second group of conductive patterns.

Since the electronic device according to an embodiment transmits the first signal to the electronic pen through the second group of conductive patterns having a relatively wide width, waste of power may be reduced.

According to an embodiment, the touch sensor may include a plurality of first electrodes (e.g., the plurality of first electrodes 410 of FIG. 5) arranged in the second direction. According to an embodiment, the touch sensor may include a plurality of second electrodes (e.g., the plurality of second electrodes 420 of FIG. 5) arranged in the first direction. According to an embodiment, the first group of conductive patterns may include a plurality of first conductive patterns (e.g., the plurality of first conductive patterns 511 of FIG. 5) extending in the first direction to cross the plurality of first electrodes and spaced apart from each other in the first direction. According to an embodiment, the first group of conductive patterns may include at least one second conductive line (e.g., the at least one second conductive line 512 of FIG. 5) extending in the second direction to connect the plurality of first conductive patterns.

The electronic device according to an embodiment may provide a structure capable of reducing damage to the electromagnetic sensor since the plurality of first conductive patterns and the at least one second conductive line forming the first group of conductive patterns are disposed in the touch sensor.

According to an embodiment, the plurality of first electrodes, the plurality of second electrodes, and the first group of conductive patterns may be disposed in a single layer within the touch sensor.

The electronic device according to an embodiment may provide a structure capable of reducing damage to the electromagnetic sensor by the electrodes in the touch sensor and the first group of conductive patterns defining the single layer.

According to an embodiment, the first group of conductive patterns may be arranged in the second direction and connected to each other.

According to an embodiment, the second group of the conductive patterns may include a first coil (e.g., the first coil 520a of FIG. 6A) disposed in the folding part According to an embodiment, a portion of the first coil may be curved with respect to the first direction.

The electronic device according to an embodiment may provide a structure capable of reducing damage to the electromagnetic sensor since the first coil is curved to bypass the plurality of openings.

According to an embodiment, the second group of conductive patterns may include a plurality of third conductive patterns (e.g., the plurality of third conductive patterns 521 of FIG. 8) extending in the first direction and spaced apart from each other in the second direction. According to an embodiment, the second group of conductive patterns may include at least one fourth conductive pattern (e.g., the at least one fourth conductive pattern 522 of FIG. 8) extending in the second direction to connect the plurality of third conductive patterns.

According to an embodiment, the second group of conductive patterns may be disposed on the supporting plate to be overlapped with each other.

According to an embodiment, the first group of conductive patterns may be transparent. According to an embodiment, the second group of conductive patterns may be opaque.

The electronic device according to an embodiment may provide a structure in which light emitted from a pixel of the display may be easily transmitted to the outside of the electronic device since the first group of conductive patterns disposed in the display is substantially transparent.

According to an embodiment, the at least one control circuit may be configured to transmit the first signal to the electronic pen through the second group of conductive patterns during a first time section. According to an embodiment, the at least one control circuit may be configured to identify, after the first time section is elapsed, a position of the electronic pen in the first direction through the second group of conductive patterns during a second time section. According to an embodiment, the at least one control circuit may be configured to identify, after the second time section is elapsed, a position of the electronic pen in the second direction through the first group of conductive patterns during a third time section.

According to an embodiment, the touch layer may be disposed above a plurality of pixels within the display. According to an embodiment, the supporting plate may be disposed below the plurality of pixels.

According to an embodiment, the electronic device may include a magnetic field shielding sheet (e.g., the shielding sheet 340 of FIG. 3) disposed below the supporting plate.

According to an embodiment, the electronic device may include a conductive sheet (e.g., the conductive sheet 350 of FIG. 3) disposed below the magnetic field shielding sheet.

According to an embodiment, the folding part may be foldable based on a folding axis perpendicular to the second direction.

An electronic device (e.g., the electronic device 200 of FIG. 4) is provided. According to an embodiment, the electronic device may include a first housing (e.g., the first housing 210 of FIG. 3). According to an embodiment, the electronic device may include a second housing (e.g., the second housing 220 of FIG. 3) According to an embodiment, the electronic device may include a hinge structure (e.g., the hinge structure 250 of FIG. 3) rotatably connecting the first housing and the second housing. According to an embodiment, the electronic device may include a display (e.g., the display 310 of FIG. 3) including a first planar part (e.g., the first planar part 311 of FIG. 3) disposed on the first housing, a second planar part (e.g., the second planar part 312 of FIG. 3) disposed on the second housing, and a folding part (e.g., the folding part 313 of FIG. 3) disposed between the first planar part and the second planar part and foldable. According to an embodiment, the electronic device may include a touch sensor (e.g., the touch sensor 400 of FIG. 4) for receiving a touch input on the display and integrally formed with the display. According to an embodiment, the electronic device may include a supporting plate (e.g., the supporting plate 320 of FIG. 3) supporting the display and including a plurality of openings aligned with the folding part. According to an embodiment, the electronic device may include a first group of conductive patterns (e.g., the first group of conductive patterns 510 of FIG. 5) disposed in the touch sensor and respectively extending in a first direction and a second group of conductive patterns (e.g., the second group of conductive patterns 520 of FIG. 6A) disposed on the supporting plate and respectively extending along a second direction crossing the first direction. According to an embodiment, the electronic device may include at least one control circuit. According to an embodiment, the at least one control circuit may be configured to provide power to at least one of the first group of conductive patterns and the second group of conductive patterns to transmit a first signal for inducing an electromagnetic resonance to an electronic pen. According to an embodiment, the at least one control circuit may be configured to receive a second signal from the electronic pen, for identifying a position of the electronic pen, caused by the first signal, through the first group of conductive patterns and the second group of conductive patterns.

According to an embodiment, the at least one control circuit may be configured to transmit the first signal to the electronic pen through the second group of conductive patterns of the first group of conductive patterns and the second group of conductive patterns.

Since the electronic device according to an embodiment transmits the first signal to the electronic pen through the second group of conductive patterns having a relatively low resistance, waste of power may be reduced.

According to an embodiment, the touch sensor may include a plurality of first electrodes (e.g., the plurality of first electrodes 410 of FIG. 5) arranged in the second direction. According to an embodiment, the touch sensor may include a plurality of second electrodes (e.g., the plurality of second electrodes 420 of FIG. 5) arranged in the first direction. According to an embodiment, the first group of conductive patterns may include a plurality of first conductive patterns (e.g., the plurality of first conductive patterns 511 of FIG. 5) extending in the first direction to cross the plurality of first electrodes and spaced apart from each other in the first direction. According to an embodiment, the first group of conductive patterns may include at least one second conductive line (e.g., the at least one second conductive line 512 of FIG. 5) extending in the second direction to connect the plurality of first conductive patterns.

The electronic device according to an embodiment may provide a structure capable of reducing damage to the electromagnetic sensor since the plurality of first conductive patterns and the at least one second conductive line forming the first group of conductive patterns are disposed in the touch sensor.

According to an embodiment, the second group of conductive patterns may include a plurality of third conductive patterns (e.g., the plurality of third conductive patterns 521 of FIG. 8) extending in the first direction and spaced apart from each other in the second direction. According to an embodiment, the second group of conductive patterns may include at least one fourth conductive pattern (e.g., the at least one fourth conductive pattern 522 of FIG. 8) extending in the second direction to connect the plurality of third conductive patterns.

According to an embodiment, the first group of conductive patterns may be transparent. According to an embodiment, the second group of conductive patterns may be opaque.

The electronic device according to an embodiment may provide a structure in which light emitted from a pixel of the display may be easily transmitted to the outside of the electronic device since the first group of conductive patterns disposed in the display is substantially transparent.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. As used herein, each of such phrases as “A or B,” “at least one of A and B,” “at least one of A or B,” “A, B, or C,” “at least one of A, B, and C,” and “at least one of A, B, or C,” may include any one of or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” or “connected with” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between a case in which data is semi-permanently stored in the storage medium and a case in which the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
a display including a first planar part, a second planar part, and a folding part disposed between the first planar part and the second planar part;
a touch sensor for receiving a touch input and disposed in the display;
a supporting plate supporting the display and including a plurality of openings aligned with the folding part;
a first group of conductive patterns disposed in the touch sensor and respectively extending in a first direction;
a second group of conductive patterns disposed on the supporting plate and respectively extending along a second direction crossing the first direction; and
at least one control circuit,
wherein the at least one control circuit is configured to:
transmit a first signal, for inducing an electromagnetic resonance, to an electronic pen through at least one of the first group of conductive patterns and the second group of conductive patterns, and
receive a second signal from the electronic pen, for identifying a position of the electronic pen, caused by the first signal, through the first group of conductive patterns and the second group of conductive patterns.

2. The electronic device of claim 1, wherein the at least one control circuit is configured to transmit the first signal to the electronic pen, through the second group of conductive patterns.

3. The electronic device of claim 1, wherein a width of the first group of conductive patterns is narrower than a width of the second group of conductive patterns.

4. The electronic device of claim 1, wherein the touch sensor further includes:
a plurality of first electrodes arranged in the second direction, and
a plurality of second electrodes arranged in the first direction, and wherein the first group of conductive patterns further includes:
a plurality of first conductive patterns extending in the first direction to cross the plurality of first electrodes and spaced apart from each other in the second direction, and
at least one second conductive line extending in the second direction to connect the plurality of first conductive patterns.

5. The electronic device of claim 4, wherein the plurality of first electrodes, the plurality of second electrodes, and the first group of conductive patterns are disposed in a single layer within the touch sensor.

6. The electronic device of claim 1, wherein the first group of conductive patterns is arranged in the second direction and connected to each other.

7. The electronic device of claim 1,
wherein the second group of conductive patterns includes a first pattern disposed in the folding part, and
wherein a part of the first pattern is curved with respect to the first direction.

8. The electronic device of claim 1, wherein the second group of conductive patterns includes:
a plurality of third conductive patterns extending in the first direction and spaced apart from each other in the second direction, and
at least one fourth conductive pattern extending in the second direction to connect the plurality of third conductive patterns.

9. The electronic device of claim 1, wherein the second group of conductive patterns is disposed on the supporting plate to be overlapped with each other.

10. The electronic device of claim 1,
wherein the first group of conductive patterns has a mesh shape, and
wherein the second group of conductive patterns is opaque.

11. The electronic device of claim 1, wherein the at least one control circuit is configured to:
transmit, the first signal to the electronic pen through the second group of conductive patterns during a first time section,
identify, after the first time section is elapsed, a position of the electronic pen in the first direction through the second group of conductive patterns during a second time section, and
identify, after the second time section is elapsed, a position of the electronic pen in the second direction through the first group of conductive patterns during a third time section.

12. The electronic device of claim 1,
wherein the touch sensor is disposed above a plurality of pixels within the display, and
wherein the supporting plate is disposed below the plurality of pixels.

13. The electronic device of claim 1, further including:
a magnetic field shielding sheet disposed below the supporting plate.

14. The electronic device of claim 13, further including:
a conductive sheet disposed below the magnetic field shielding sheet.

15. The electronic device of claim 1, wherein the folding part is foldable based on a folding axis perpendicular to the second direction.

16. An electronic device comprising:
a first housing;
a second housing;
a hinge structure rotatably connecting the first housing and the second housing;
a display including a first planar part disposed on the first housing, a second planar part disposed on the second housing, and a folding part disposed between the first planar part and the second planar part and foldable;
a touch sensor for receiving a touch input on the display and integrally formed with the display;
a supporting plate supporting the display and including a plurality of openings aligned with the folding part;
a first group of conductive patterns disposed in the touch sensor and respectively extending in a first direction;
a second group of conductive patterns disposed on the supporting plate and respectively extending in a second direction crossing the first direction; and
at least one control circuit,
wherein the at least one control circuit is configured to:
provide power to at least one of the first group of conductive patterns and the second group of conductive patterns to transmit a first signal for inducing an electromagnetic resonance to an electronic pen, and
receive a second signal from the electronic pen, for identifying a position of the electronic pen, caused by the first signal, through the first group of conductive patterns and the second group of conductive patterns.

17. The electronic device of claim 16, wherein the at least one control circuit is configured to transmit a first signal to the electronic pen, through the second group of conductive patterns.

18. The electronic device of claim 16,
wherein the touch sensor further includes:
a plurality of first electrodes arranged in the second direction, and
a plurality of second electrodes arranged in the first direction, and wherein the first group of conductive patterns includes:
a plurality of first conductive patterns extending in the first direction to cross the plurality of first electrodes and spaced apart from each other in the first direction, and
at least one second conductive line extending in the first direction to connect the plurality of first conductive patterns.

19. The electronic device of claim 16, wherein the second group of conductive patterns includes:
a plurality of third conductive patterns extending in the first direction and spaced apart from each other in the second direction, and
at least one fourth conductive pattern extending in the second direction to connect the plurality of third conductive patterns.

20. The electronic device of claim 16,
wherein the first group of conductive patterns has a mesh shape, and
wherein the second group of conductive patterns is opaque.
